(19) United States
(12) Patent Application Publication
(10) Pub. No.: US 2010/0098042 A1
(43) Pub. Date: Apr. 22, 2010

(54) USING THE SAME MULTIPLEXED RADIO RESOURCE FOR PILOT AND INFORMATION SIGNALS

(76) Inventor: Paul Wilkinson Dent, Pittsboro, NC (US)

Correspondence Address: ERICSSON INC., 6300 LEGACY DRIVE, M/S EVR 1-C-11, PLANO, TX, 75024, US

(21) Appl. No.: 12/255,343

(22) Filed: Oct. 21, 2008

(51) Int. Cl. H04B 7/216; H04B 7/00; H04B 7/212; H04J 11/00

(52) U.S. Cl. 370/342; 370/310; 370/347; 370/343

(57) ABSTRACT

A method and apparatus for using the same multiplexed radio resource to simultaneously transmit a pilot sequence and an information signal is described herein. After traveling through a multi-path propagation channel, a receiver receives the transmitted pilot and information signals, correlates the received signal with the known pilot sequence to determine one or more correlation values, and estimates the multi-path propagation channel based on the correlation values. The receiver uses the channel estimates to process the received signal to remove the pilot sequence from the information signal. By using the same multiplexed radio resource to transmit both the pilot sequence and the user information signal, the present invention enables more radio resources to be allocated to the information signal without compromising pilot-based channel estimation, and provides more regular access to the transmitted pilot sequence at the receiver.

### BACKGROUND

The present invention generally relates to wireless communications, and particularly relates to estimating the propagation channel between a transmitter and a receiver.

Information signals transmitted to a wireless receiver travel through a multi-path propagation channel that distorts the amplitude and phase of the signal. To obtain high data rates, receivers estimate the propagation channel and process the received signal to mitigate the adverse affects of the propagation channel. To facilitate this effort, a transmitter typically transmits a known pilot sequence to the receiver. The receiver processes the known pilot sequence to estimate the propagation channel. For example, the receiver may correlate the known pilot sequence with the received pilot sequence, and estimate the propagation channel based on the correlation values.

In conventional systems, the transmitter allocates separate radio resources to the information signal and the pilot sequence. For example, in a TDMA (Time Division Multiple Access) or FDMA (Frequency Division Multiple Access) system, the transmitter transmits pilot symbols at different time instants than information symbols. In a CDMA (Code Division Multiple Access) system, the transmitter allocates different orthogonal spreading codes to the pilot sequence and information signal. In an OFDM (Orthogonal Frequency Division Multiplex) system, which uses multiple subcarrier frequencies to transmit information, the transmitter allocates different ones of the subcarrier frequencies to the pilot symbol sequence than to the information signal. In all cases, the pilot symbol sequence steals radio resources that may have otherwise been used for the information signal.

To satisfy the increasing demand for a wide variety of wireless multi-media, wireless communications systems may require higher data rates, e.g., through the use of higher order modulation constellations, such as 16 QAM. Processing higher data rate signals requires higher signal to noise ratios to obtain an acceptable error rate. Further, processing higher data rate signals requires more accurate channel estimation. Due to the limited radio resources available to the transmitter and the limited processing resources available at the receiver, obtaining sufficiently accurate channel estimates is becoming increasingly challenging. For example, an information signal and pilot sequence sent at different time instances in a TDMA or FDMA system prevents mutual interference caused by time overlap of the pilot sequence with the information signal, which enables the receiver to estimate the propagation channel from the received pilot sequence. However, if the phase of the propagation channel changes with time, the received pilot sequence yields channel or phase information at different instants of time than required to decode the received information signal. To account for time differences in the phase information, the receiver may use interpolation or “channel tracking” to obtain the required channel estimates. Channel tracking may be difficult when the channel changes rapidly, such as in high speed environments, or when the signal-to-noise ratio is low. Thus, there is a need for an improved method of providing accurate channel estimates on a more continuous basis without unduly increasing the overhead or the spectral occupancy for pilot symbols.

### SUMMARY

The present invention comprises a method and apparatus that uses the same multiplexed radio resource to simultaneously transmit a pilot sequence and an information signal. For example, a TDMA network may transmit the pilot sequence and information signal at the same time instants (e.g., in the same symbol periods, in an allocated time slot, an OFDM network may transmit the pilot sequence and information signal using the same set of subcarrier frequencies during the same OFDM symbol block period, or a CDMA network may transmit the pilot sequence and information signal using the same orthogonal spreading code.

After traveling through the multi-path propagation channel, the transmitted pilot and information signals are received at the receiver. The receiver correlates the received signal with the known pilot sequence to determine one or more correlation values, and estimate the multi-path propagation channel based on the correlation values. The receiver then uses the channel estimates to process the received signal to remove the pilot sequence from the information signal. In one embodiment, the receiver multiplies the known pilot sequence by the determined channel estimates to determine a received pilot sequence estimation, and subtracts the received pilot sequence estimation from the received signal to remove the pilot sequence from the received information signal. In another embodiment, the receiver decodes the received signal using the determined channel estimates to remove the pilot sequence from the information signal while simultaneously decoding the information signal.

By using the same multiplexed radio resource to transmit both the pilot sequence and the user information signal, the present invention enables more radio resources to be allocated to the information signal without compromising pilot-based channel estimation. Further, because the pilot sequence and the information signal are received at the same time, the present invention provides more regular access to the pilot sequence. Thus, using the same multiplexed radio resource for both the pilot sequence and the information signal enables channel estimation on a more continuous basis.

### BRIEF DESCRIPTION OF THE DRAWINGS

FIG. 1 shows a wireless communication system according to one exemplary embodiment of the present invention.

FIG. 2 shows a transmission method according to one exemplary embodiment of the present invention.

FIG. 3 shows a reception method according to one exemplary embodiment of the present invention.

FIG. 4 shows an OFDM baseband processor and controller for the wireless transmitter of FIG. 1 according to one exemplary embodiment of the present invention.

FIG. 5 shows an exemplary OFDM symbol overlapping an exemplary pilot sequence.

FIG. 6 shows exemplary overlapping OFDM symbols aligned with exemplary pilot sequences.

FIG. 7 shows a receiver according to one exemplary embodiment of the present invention.

FIG. 8 shows OFDM pulse shaping according to one exemplary embodiment of the present invention.

FIG. 9 shows a transmitting unit for the transmitter of FIG. 1 according to one exemplary embodiment of the present invention.

FIG. 10 shows a method for generating a pilot sequence according to one exemplary embodiment of the present invention.

FIG. 11 shows an exemplary TDMA burst overlapping an exemplary pilot sequence.

FIG. 12 shows a TDMA baseband processor and controller for the wireless transmitter of FIG. 1 according to one exemplary embodiment of the present invention.

FIG. 13 shows a signal processor for the receiver of FIG. 7 according to one exemplary embodiment of the present invention.

FIG. 14 shows a signal processor for the receiver of FIG. 7 according to one exemplary embodiment of the present invention.

FIG. 15 shows a set of eight orthogonal Walsh codes.

FIG. 16 shows a CDMA baseband processor and controller for the wireless transmitter of FIG. 1 according to one exemplary embodiment of the present invention.

FIG. 17 shows the progression of CDMA signals as they pass through the CDMA baseband processor of FIG. 16 according to one exemplary embodiment of the present invention.

### DETAILED DESCRIPTION

The present invention simultaneously transmits a pilot sequence and a user information signal using the same multiplexed radio resource, e.g., time, frequency, or orthogonal spreading code, which allows the pilot sequence to occupy the same frequency, time, or orthogonal code resource as the user information signal. Further, the present invention avoids interference between the pilot sequence and the user information signal by removing the known pilot sequence at the receiver. In so doing, the present invention provides a method of transmitting the pilot sequence used for channel estimation without reducing the radio resources available for user information signal. The present invention is applicable to any wireless communication system that uses a multiplexed radio resource, such as a TDMA, CDMA, or FDMA system. For simplicity, the details of the invention are described in terms of an Orthogonal Frequency Division Multiplexed (OFDM(system, which is a specific type of FDMA system. The following assumes the OFDM system has N=1024 subcarrier frequencies, each 5 kHz wide. It will be appreciated that the described OFDM system is not limited to 1024 subcarrier frequencies or to a 5 kHz subcarrier bandwidth.

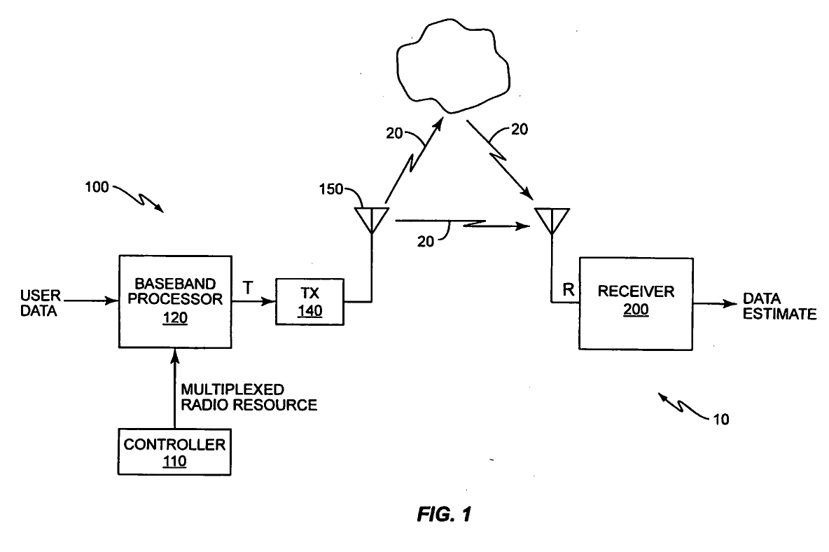

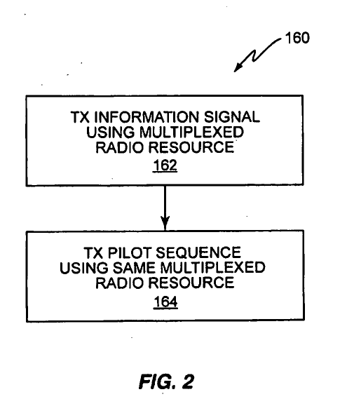

FIG. 1 shows a wireless communication system 10 comprising a transmitter 100 that simultaneously sends the pilot and information signals to a receiver 200 via a multi-path propagation channel 20 according to the method 160 of FIG. 2. Transmitter 100 comprises a controller 110, a baseband processor 120, a transmitting unit 140, and one or more antennas 150. Controller 110 allocates a multiplexed radio resource to the transmitter 100 based on a current operating communication standard and available radio resources. For example, controller 110 may allocate a set of subcarrier frequencies when the wireless communication system 10 comprises an OFDM system. Baseband processor 120 processes the input user data to generate an information signal. The baseband processor 120 further transmits the information signal using an allocated multiplexed radio resource (block 162), and simultaneously transmits a pilot sequence using the same allocated multiplexed radio resource (block 164). The transmitting unit 140 formats the combined pilot and information signal T for transmission via antenna 150 by, e.g., performing digital-to-analog conversion, frequency up-conversion, and amplification. Thus, transmitter 100 simultaneously transmits a user information signal and a pilot sequence using the same multiplexed radio resource.

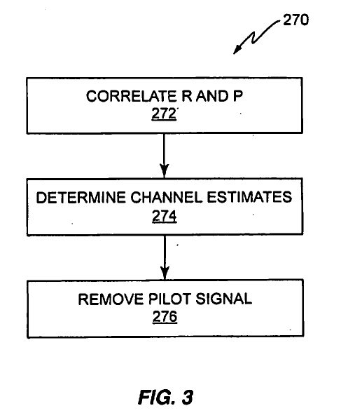

Receiver 200 receives and processes the multi-path signals according to the exemplary method 270 shown in FIG. 3. Receiver 200 correlates the received signal with the known pilot sequence to determine correlation values (block 272). The receiver 200 then processes the correlation values to determine a set of coefficients of the impulse response of the entire wideband channel 20 (block 274). The set of coefficients of the wideband channel impulse response are referred to herein as the channel estimates. Receiver 200 further processes the received signal based on the determined channel estimates to remove the pilot sequence from the information signal and generate an estimate of the information signal (block 276). For example, the receiver 200 may subtract an estimate of the received pilot signal from the received signal or may decode the received signal using the determined channel estimates to simultaneously decode the information signal and remove the pilot sequence.

FIG. 3 shows one exemplary baseband processor 120 for an OFDM transmitter 100. Controller 110 allocates data bits to N subcarrier frequencies, e.g., N=1024. Conventionally, some bits would comprise user information bits and other bits would comprise pilot bits. In the present invention, all of the bits may comprise user information bits. Baseband processor 120 comprises a serial-to-parallel converter 122, N mapping units 124, an N-point discrete Fourier transform (DFT) unit 126, a parallel-to-serial converter 128, and combiners 130. The serial-to-parallel converter 122 converts the input data bits to N groups of parallel bits. Each mapping unit 124 maps a group of corresponding input parallel bits to a complex symbol value Sₙ, where n=1, 2, . . . , N, using a suitable complex modulation constellation. Thus, mapping units 124 output up to N=1024 complex symbol values, which are input to the N-point DFT unit 126. Alternatively, a mapping unit 124 may be positioned before the serial-to-parallel converter 122, so that the bits are mapped to complex symbol values sequentially. The serial-to-parallel converter 122 then converts the serial stream of complex symbol values to N parallel complex symbol values for input at the same time to DFT unit 126.

DFT unit 126, which may comprise an inverse Fast Fourier Transform (FFT) unit, applies an inverse Fourier transform to each input block of N complex symbol values to output N complex OFDM samples, collectively referred to herein as an OFDM symbol or sample block D. Each of the N complex OFDM samples comprises an In-phase component D_{In} and a Quadrature-phase component D_{Qn}. Parallel-to-serial converter 128 serializes the complex samples to generate a complex information signal, which comprises an In-phase component D_{I} and a Quadrature-phase component D_{Q}. If submitted to a spectral analysis using a Fourier Transform, the now time-serial complex sequence (D_{I}, D_{Qn}) would seem to be composed of the N desired subcarrier frequencies, each modulated with one of the N input complex symbol values Sₙ.

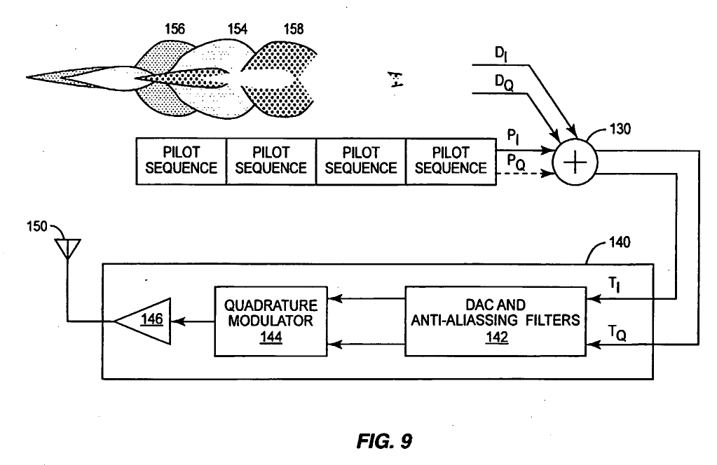

In some embodiments, DFT unit 126 comprises a K-point DFT unit 126, where K>N. The over-dimensioned DFT unit 126 transforms more than the N input symbol values. The extra inputs of the over-dimensioned DFT unit 126 beyond those required to accept the input symbol values S₁, S₂, . . . S_{N} are set to a zero sample value. The outputs of the over-dimensioned DFT unit 126 comprise more than one sample per Hz of bandwidth. For example, if the over-dimensioning factor is 2:1, so that there are N user symbol value inputs and N zero value inputs, then the output comprises two time domain samples per Hz of bandwidth. The benefit of having more than 1 sample per Hz of bandwidth is that unwanted aliasing components in the signal spectrum are distanced from the desired signal component, which makes the job of anti-aliasing filters (FIG. 9) in the transmitting unit 140 easier.

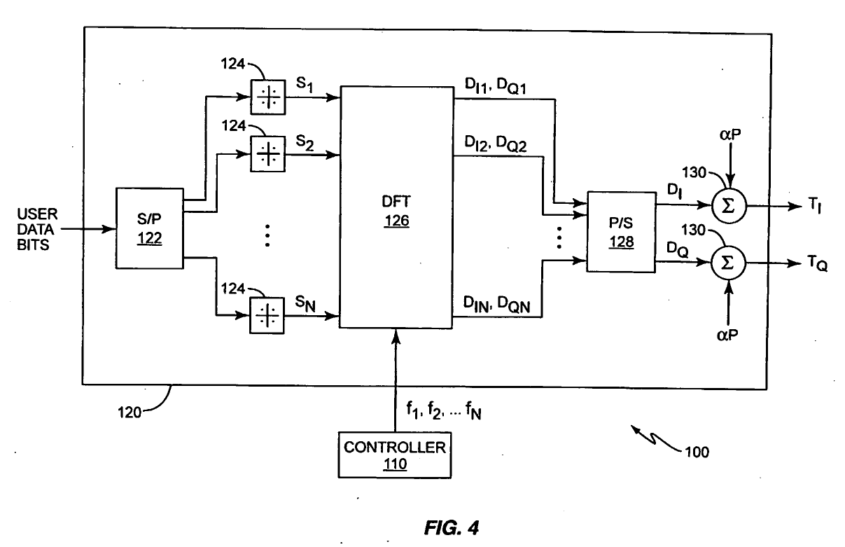

To apply the same multiplexed radio resource to the pilot sequence, e.g., the same set of subcarrier frequencies, combiners 130 linearly combine D_{I} and/or D_{Q} with a predetermined pilot sequence P, where the amplitude of the pilot sequence P is given by a gain factor α. The linear addition occurs before frequency up-conversion in the transmitting unit 140, and therefore, before the addition of transmission path noise and multi-path distortion. While the combination is shown as being performed in the digital numerical domain, combiners 130 may alternatively linearly combine analog representations of the OFDM symbol and pilot sequence. Also, while FIG. 4 shows the same pilot sequence being separately added to both D_{I} and D_{Q}, it will be appreciated that the pilot sequences may only be added to one of D_{I} and D_{Q}. Alternatively, different pilot sequences may be added to D_{I} and D_{Q}. Further, the signal values of the pilot sequence may be added individually to each I and/or Q sample output by DFT 126 before being input to the parallel-to-serial converter 128.

The pilot sequence is linearly added to the OFDM samples before filtering through any filters, such as anti-aliasing filters (FIG. 9), which may have a root-Nyquist pulse-shape. The use of root-Nyquist filters or pulse-shapes in the transmitter 100 means that, after similar filtering or weighting at the receiver 200, the overall system pulse-shape has the Nyquist property.

An ideal pilot sequence comprises a pseudo-random number (PRN) sequence having M=2^{l}−1 signal values, e.g., binary signal values such as bits, where M is just one signal value less than the number of samples in the OFDM symbol. Preferably, the sequence has a flat spectrum that equally affects each OFDM frequency channel. Thus, in the current example of an OFDM symbol of 1024 samples, an ideal pilot sequence comprises a Maximum Length Sequence (MLS) comprising 1023 signal values.

For purposes of illustration, the following describes the pilot sequence in terms of an MLS. It will be appreciated, however, that the pilot sequence may comprise any PRN sequence. The baseband processor 120 generates the M=2^{l}−1 signal values of the MLS, e.g., using a feedback shift register, where l represents the length of the register, and where 2^{l} generally equals the number of OFDM samples N. Cyclic rotations of the MLS are nearly orthogonal to each other and have a correlation of −1/M. This property is almost ideal for generating pilot sequences used to estimate the impulse response of multi-path propagation channel.

There are 30 different, known MLSs of length 1023 that may be used. The feedback register taps that produce maximum length sequences are known and published, and the table below gives the known taps for a 10-state register producing sequences of length 1023.

| 2 Taps | | 4 Taps | | | | 6 Taps | | | | | | 8 Taps | | | | | | | |
|---|---|---|---|---|---|---|---|---|---|---|---|---|---|---|---|---|---|---|---|
| 10 | 7 | 10 | 9 | 8 | 5 | 10 | 9 | 8 | 7 | 5 | 4 | 10 | 9 | 8 | 7 | 6 | 5 | 4 | 3 |
| | | 10 | 9 | 7 | 6 | 10 | 9 | 8 | 7 | 4 | 1 | 10 | 9 | 8 | 7 | 6 | 5 | 4 | 1 |
| | | 10 | 9 | 7 | 3 | 10 | 9 | 8 | 7 | 3 | 2 | 10 | 9 | 8 | 7 | 6 | 4 | 3 | 1 |
| | | 10 | 9 | 6 | 1 | 10 | 9 | 8 | 6 | 5 | 1 | 10 | 9 | 8 | 6 | 5 | 4 | 3 | 2 |
| | | 10 | 9 | 5 | 2 | 10 | 9 | 8 | 6 | 4 | 3 | 10 | 9 | 7 | 6 | 5 | 4 | 3 | 2 |
| | | 10 | 9 | 4 | 2 | 10 | 9 | 8 | 6 | 4 | 2 | | | | | | | | |
| | | 10 | 8 | 7 | 5 | 10 | 9 | 8 | 6 | 3 | 2 | | | | | | | | |
| | | 10 | 8 | 7 | 2 | 10 | 9 | 8 | 6 | 2 | 1 | | | | | | | | |
| | | 10 | 8 | 5 | 4 | 10 | 9 | 8 | 5 | 4 | 3 | | | | | | | | |
| | | 10 | 8 | 4 | 3 | 10 | 9 | 8 | 4 | 3 | 2 | | | | | | | | |
| | | | | | | 10 | 9 | 7 | 6 | 4 | 1 | | | | | | | | |
| | | | | | | 10 | 9 | 7 | 5 | 4 | 2 | | | | | | | | |
| | | | | | | 10 | 9 | 6 | 5 | 4 | 3 | | | | | | | | |
| | | | | | | 10 | 8 | 7 | 6 | 5 | 2 | | | | | | | | |

Codes derived from different MLSs are not mutually orthogonal but just exhibit random correlation with cyclic rotations of each other.

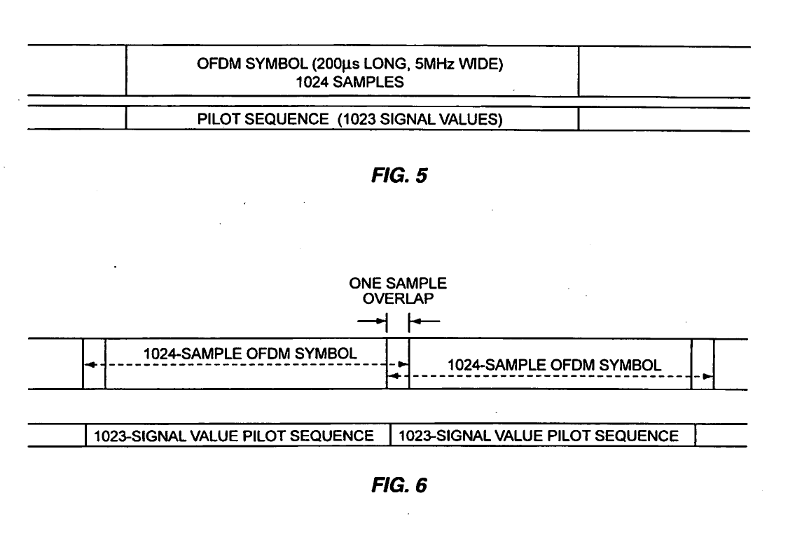

FIG. 5 shows how one exemplary 1024-sample OFDM information symbol output by DFT unit 126 may overlap an MLS of length M=1023. The smaller height of the pilot sequence signal values indicates that the pilot sequence may generally be given a lower power than the OFDM symbol, which is determined by choice of α. For example, the pilot sequence power may be 10% of the OFDM symbol power, i.e., the pilot sequence amplitude may be less than ⅓ of the OFDM symbol amplitude. Losing 10% of the OFDM symbol power to the pilot sequence represents only a 0.5 dB loss in the transmission efficiency. This loss is exactly the same loss that occurs when a TDMA signal comprises 10% pilot sequence and 90% user data. However, linear combination of the pilot sequence and information signal reuses the subcarrier frequencies, which provides the added benefit of reducing the bandwidth occupancy by 10% over conventional method for transmitting OFDM pilot sequences. Thus, the power/energy diverted to the pilot sequence is similar in all systems, but the current invention has the advantage of better spectral efficiency.

The overlap of the known pilot sequence with the OFDM symbol will not interfere with the OFDM symbol because the known pilot sequence may be subtracted out or otherwise removed when the receiver 200 decodes the symbols. The sample values in the OFDM symbol may interfere with the pilot sequence signal values unless the interference is removed after or during the decoding process. For example, a so-called two-pass decoding process may be used, whereby channel estimation is repeated after a first attempt at decoding the data by subtracting the influence of the just decoded data, followed by a second attempt at decoding data with the improved channel estimates. However, if the system is operating at negative signal to noise ratios, as may arise in satellite communications systems, the pilot sequence signal values are affected less by overlapping data symbols than by noise. Moreover, while only a fraction of the shared radio resource was conventionally devoted to the pilot sequence, the entire radio resource may be occupied by both user and pilot data in the present invention. As such, there are more pilot symbols available for channel estimation.

As shown in FIG. 5, the MLS has one less signal value than the number of samples in the OFDM information symbol. The MLS signal values may thus be added one signal value per OFDM sample, where the length mismatch may be handled in a number of optional ways. For example, if a 1023-signal value MLS is repeated and superimposed on a 1024-sample OFDM symbol, the alignment between the MLS and consecutive OFDM symbols will shift by one sample for each successive symbol, and will repeat after 1023 symbols. With a symbol duration of about 0.2 ms, the MLS pattern repeats approximately every 0.2 seconds, which is not excessive, and which may be denoted as a “frame.” For this scenario, it is important to devise a method of agreeing on system timing so that the receiver 200 knows which of the 1023 symbols in a frame it is currently decoding, and therefore, which cyclic pilot sequence shift to use for channel estimation. Thus, the mismatch between the size of an OFDM information symbol and the length of an MLS may be turned into a feature, namely the provision of a system clock structure.

Alternatively, it may be preferable to provide the same alignment between the MLS and each OFDM symbol. One embodiment aligns the MLS by augmenting the length of the MLS to 1024 signal values to generate an extended MLS. Another embodiment aligns the MLS by overlapping successive OFDM symbols by one sample, as shown in FIG. 6, to effectively create OFDM symbols with 1023 samples instead of 1024. When the duration of a sample is 0.2 μs, such overlap has a negligible effect that is somewhat equivalent to a 0.2 μs channel multi-path delay spread. For example, in the land mobile environment, communications systems should be designed to handle up to 16 μs of delay spread, making the 0.2 μs delay spread attributable to a one-sample overlap between OFDM symbols of no significance. Thus, it possible to use a cyclically repeated 1023-signal value MLS that exactly aligns with every 1024-sample OFDM block symbol.

The transmitting unit 140 processes and transmits the combined pilot and information signal output by the baseband processor 100 using any known means. For example, the transmitting unit 140 may include a digital-to-analog converter/filter unit 142 to convert the digital combined signal to an analog combined signal and filter the analog combined signal using anti-aliasing filters, a modulator 144 to up-convert the filtered signal to a radio frequency using, e.g., a quadrature modulator, and an amplifier 146 to amplify the up-converted signal, as shown in FIG. 9. The transmitting unit 140 transmits the amplified signal to the receiver 200 via antenna(s) 150.

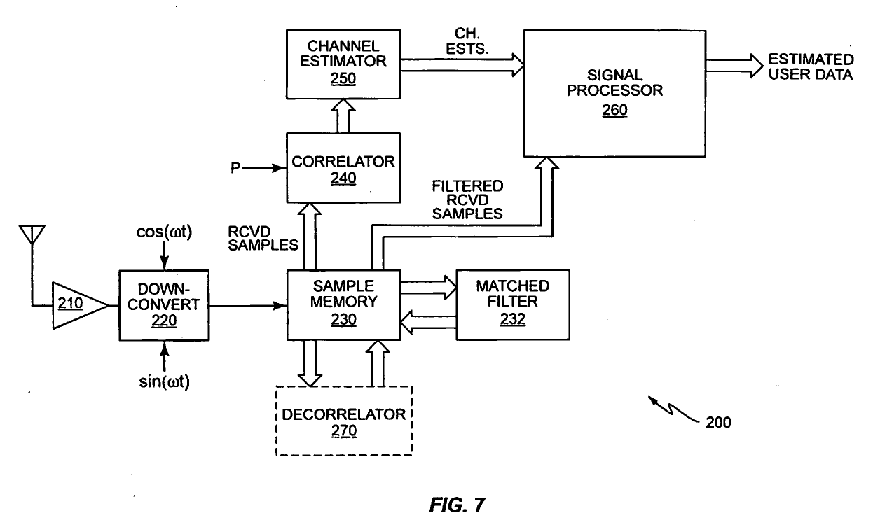

Receiver 200 estimates the propagation channel between the transmitter 100 and receiver 200 by correlating the received signal with the known pilot sequence. To that end, FIG. 7 shows one exemplary receiver 200 comprising a low noise amplifier (LNS) 210, downconverter 220, sample memory 230, matched filter 232, correlator 240, channel estimator 250, and signal processor 260. LNA 210 amplifies the received signal, and downconverter 220 down-converts the received signal from RF to the complex baseband. Sample memory 230 performs serial-to-parallel conversion by collecting and storing samples. Further, other signal processing functions may read values from memory 230 and write modified values back into memory 230. Matched filter 232, which may comprise a sample-matched filter, a pulse-shaped matched filter for pulse-shaped OFDM, or both, filters collected and stored samples from memory 230. Correlator 240 correlates received samples with the known pilot sequence, before or after filtering by the matched filter 232, as described further herein. Channel estimator 250 estimates the channel for each OFDM subcarrier frequency based on the correlations output by the pilot correlator 240. For example, the channel estimator 250 may compute an impulse response based on the pilot correlations, and perform a Fourier Transform on the impulse response to obtain a frequency response comprising the phase and amplitude of the channel at every subcarrier frequency. Signal processor 260 processes the filtered signal using the channel estimates to remove the pilot sequence from the desired information signal and to decode the user data, as described further herein. It will be appreciated that matched filter 232 may be implemented as part of the signal processor 260.

Some practical designs of a digital signal processor 260 for the radio receiver 200 use the memory 230 to buffer the outputs of the various processing stages and hold them for input to the next stage. A high-level, software-driven control unit issues commands to each processing unit 232, 240, 260, etc., to indicate from where in memory 230 it should take its input, what function it should perform, and to where in memory 230 it should write its output. The software operating system would typically receive an interrupt from that processing unit 232, 240, 260 when the corresponding commanded operation was complete, indicating that results were now available to start the next processing function. In this way, by editing instructions in the control software, the order in which functions are performed may be changed until satisfactory results are achieved.

If a single pilot sequence as described above is added to the real and/or imaginary parts of the DFT output in transmitter 100, the correlator 240 may correlate the complex received signal with cyclic rotations of the pilot sequence. If the relationship of the pilot sequence to the DFT sample block is known by virtue of the timing operations described above, this also yields the block timing.

If the cyclic shifts of a pilot sequence form an orthogonal set, correlation with all cyclic shifts may be done efficiently using the Fast Walsh-Hadamard Transform (FWT). Fast correlation with all cyclic shifts of an MLS may also be performed, e.g., by appending a column of zeros to the sequence shifts and including a 1024^{th} all zeros sequence to complete an orthogonal set of 1024, 1024-signal value sequence, sometimes referred to as the simplex sequence set or even as a “Calthrop matrix.” An extra signal sample is also appended to the signal sequence to be correlated, having the value zero in the position corresponding to the appended zero signal value. Thus, to correlate 1023 signal samples with all rotations of a 1023 MLS, the sample set may be expanded to 1024 by appending zero value in position 1024, and lengthening all sequence shifts by one to 1024 by appending an extra zero for the 1024^{th} signal value. A 1024^{th} all zeros sequence is also included to perform the Fast Orthogonal Transform. The resulting matrix is 1024×1024 and is an orthogonal set, which is just a row and column permutation of a Walsh-Hadamard matrix. The column permutation is predetermined by selection of the MLS, and the 1024 signal samples may be permuted in the same order so that a regular FWT may be performed. This permutation may be done, e.g., by addressing the MLS indirectly using a predetermined index mapping table of 1024 permuted indices. An FWT is then performed on the permuted signal samples, and the 1024 FWT results are then be permuted according to the row permutation, which may be done by addressing them via a similar predetermined index table. This method of efficiently correlating all cyclic shifts of an MLS using a Fast Walsh Transform is similar to the method for correlating with Gold codes described in U.S. Pat. No. 6,091,761 to Popovic, and entitled “Despreading method and arrangement in communications system.” It is also known that cyclic convolution of two sets of values may be performed by extending the values sets by appending zeros if necessary; Fast Fourier Transforming the extended value sets; multiplying corresponding FFT output values, and inverse transforming the product. This method is a known mathematical theorem that is applied to a specific multi-sequence correlation problem and disclosed in U.S. Pat. No. 5,463,657 to Rice, entitled “Detection of a multi-sequence spread-spectrum signal.” Rice also describes permuting the order of samples using a look-up table.

Conventionally, it was common to select a fixed set (i.e., 1023 or fewer) of signal samples for correlation with different shifts of a pilot sequence. The reason for selecting a fixed set of signal samples within a time window was typically due to a lack of knowledge of what may lie outside the window that could affect the result, due to multi-path channel time dispersion smearing the unknown bordering signals into the correlation window. In the case of continuous transmission of OFDM symbols with superimposed, repetitive pilot sequences, the samples bordering the window are not unknown, but instead are known to contain some portion of the cyclic repeat of the pilot sequence. Therefore, selection of any consecutive 1023 signal samples contains the complete pilot sequence with some cyclic rotation to be determined. This selection allows the alternative method of channel estimation to be used, whereby the correlator 240 correlates a fixed pilot sequence with different shifts of 1023 successive signal samples.

Such correlation may be performed in different ways. In a first embodiment, correlator 240 correlates the signal samples with all shifts of a pilot sequence as described by the following matrix multiplication:

$$( \begin{matrix}{C}_{1} \\ {C}_{2} \\ {C}_{3} \\ ⋮ \\ {C}_{N}\end{matrix} ) = [ \begin{matrix}{P}_{1}^{*} & {P}_{2}^{*} & … & {P}_{N - 1}^{*} & {P}_{N}^{*} \\ {P}_{N}^{*} & {P}_{1}^{*} & {P}_{2}^{*} & … & {P}_{N - 1}^{*} \\ ⋮ & & & ⋰ & ⋮ \\ ⋮ & & & & ⋮ \\ {P}_{2}^{*} & … & {P}_{N - 1}^{*} & {P}_{N}^{*} & {P}_{1}^{*}\end{matrix} ] ( \begin{matrix}{R}_{1} \\ {R}_{2} \\ {R}_{3} \\ ⋮ \\ {R}_{N}\end{matrix} ) \qquad ( 1 )$$

In Equation (1), C₁ . . . C_{N}, are the correlation values to be determined, R₁ . . . R_{N} are the received signal samples, and P₁ . . . P_{N} are the signal values of the cyclically repeating pilot sequence. When the sequence signal values are complex, as when different pilot sequences or different shifts of the same pilot sequence are used on the I and Q channels, then the complex conjugate of the pilot sequence signal values, indicated by *, shall be used. The complex conjugate may be obtained by inverting the imaginary or Q-values of the sequence.

In another embodiment, correlator 240 correlates the pilot sequence with successive hits of the received signal samples, as described by the following matrix multiplication.

$$( \begin{matrix}{C}_{1} \\ {C}_{2} \\ {C}_{3} \\ ⋮ \\ {C}_{m}\end{matrix} ) = [ \begin{matrix}{R}_{1} & {R}_{2} & … & {R}_{N - 1} & {R}_{N} \\ {R}_{2} & {R}_{3} & {R}_{4} & … & {R}_{N + 1} \\ ⋮ & & & ⋰ & ⋮ \\ ⋮ & & & & ⋮ \\ {R}_{m} & {R}_{m + N} & … & … & {R}_{m + N - 1}\end{matrix} ] ( \begin{matrix}{P}_{1}^{*} \\ {P}_{2}^{*} \\ {P}_{3}^{*} \\ ⋮ \\ {P}_{N}^{*}\end{matrix} ) \qquad ( 2 )$$

In Equation (2), the signal sample matrix comprises an m×(N+m−1) matrix. Equation (2) may be equivalently expressed by Equation (3), where the pilot sequence matrix comprises an m×(N+m−1) matrix.

$$( \begin{matrix}{C}_{1} \\ {C}_{2} \\ {C}_{3} \\ ⋮ \\ {C}_{m}\end{matrix} ) = [ \begin{matrix}{P}_{1}^{*} & {P}_{2}^{*} & … & {P}_{N}^{*} & 0 & … & 0 \\ 0 & {P}_{1}^{*} & … & {P}_{N}^{*} & 0 & … & 0 \\ ⋮ & & & ⋰ & & & ⋮ \\ ⋮ & & & & ⋰ & & ⋮ \\ 0 & … & 0 & {P}_{1}^{*} & {P}_{2}^{*} & … & {P}_{N}^{*}\end{matrix} ] ( \begin{matrix}{R}_{1} \\ {R}_{2} \\ {R}_{3} \\ ⋮ \\ {R}_{m + N + 1}\end{matrix} ) \qquad ( 3 )$$

The correlation values of Equation (3), which may be written in an abbreviated form as:

C=P^{#}R, (4)

where # represents the conjugate transpose, may alternatively be defined as those complex values that best explain the received signal, e.g., as the least squares solution of:

PC=R. (5)

The least squares solution of Equation (5) may be represented by:

C=[P^{#}P]⁻¹P^{#}R. (6)

The m×(N+m−1) matrix [P^{#}P]⁻¹P^{#} may be pre-computed and stored in memory.

The least squares solution of Equation (5) is valid if the interference from noise and overlapping data symbols on each received sample Rₙ has the same root mean square (RMS) expected value and is uncorrelated. If the noise on each Rₙ is not of equal RMS expectation or is correlated, receiver 200 may further comprise a de-correlator 270 that de-correlates the noise on the received signal. In this case, both sides of Equation (5) should first be multiplied by a de-correlating matrix X, which is the square root of the inverse of the correlation matrix C, which is presumed known or estimated by other means. A case of particular interest in this application is when the RMS expectation on different Rₙ is known to be a first value for some of the Rₙ and a second value for others, in which case the matrix X may only be diagonal, with the elements equal to the reciprocal of the expected RMS noise values. Effectively, the RMS expectation determines the least squares channel estimates while giving more weight to the least noisy Rₙ. Solving Equation (6) by this method may be attractive when the number of channel coefficients m is much less than the number of signal samples N being correlated. The latter method also compensates for the fact that different shifts of the MLS are not orthogonal to each other, but have correlation −1/L, where L is the sequence length. Thus, if the embodiment corresponding to Equation (1) is used, the resulting correlations C may relate to multi-path delay coefficients c₁, c₂, c₃, etc., by:

$$( \begin{matrix}{C}_{1} \\ {C}_{2} \\ {C}_{3} \\ ⋮ \\ {C}_{L}\end{matrix} ) = [ \begin{matrix}L & - 1 & - 1 & - 1 & … & … & - 1 \\ - 1 & L & - 1 & - 1 & - 1 & … & - 1 \\ - 1 & - 1 & L & ⋰ & & & ⋮ \\ ⋮ & & & & ⋰ & & ⋮ \\ - 1 & - 1 & - 1 & - 1 & … & … & L\end{matrix} ] ( \begin{matrix}{c}_{1} \\ {c}_{2} \\ {c}_{3} \\ ⋮ \\ {c}_{L}\end{matrix} ) , \qquad ( 7 )$$

from which it may be deduced that

$$\begin{matrix}( \begin{matrix}{c}_{1} \\ {c}_{2} \\ {c}_{3} \\ ⋮ \\ {c}_{L}\end{matrix} ) = \frac{1}{L + 1} ( \begin{matrix}{C}_{1} - {C}_{0} \\ {C}_{2} - {C}_{0} \\ {C}_{3} - {C}_{0} \\ ⋮ \\ {C}_{L} - {C}_{0}\end{matrix} ) , \\ where & ( 8 ) \\ {C}_{0} = {\sum }_{i = 1}^{L} {C}_{i} , & ( 9 )\end{matrix}$$

which also equals the result of correlating the received signal samples with the appended all zeros sequence (e.g., an all arithmetic +1 sequence). From Equation (7) it may also be deduced that each correlation value may equally well be obtained for any particular pilot sequence shift by averaging only those received signal samples corresponding to the position of a binary 1 in the pilot sequence shift.

Yet another way to correlate the received signal with cyclic shifts of the pilot sequence, e.g., as shown in Equation (1), is to note that a matrix whose successive rows are progressive cyclic shifts of the first row is diagonalizable by means of the DFT matrix as illustrated by:

$$\begin{matrix}[ \begin{matrix}{P}_{1} & {P}_{2} & & … & & {P}_{N - 1} & {P}_{N} \\ {P}_{N} & {P}_{1} & {P}_{2} & & … & & {P}_{N - 1} \\ & & & & & & \\ ⋮ & & & ⋰ & & & ⋮ \\ & & & & & & \\ ⋮ & & & & & ⋰ & ⋮ \\ & & & & & & \\ & & & & & & \\ {P}_{2} & & … & & {P}_{N - 1} & {P}_{N} & {P}_{1}\end{matrix} ] = [ \begin{matrix} \\ \\ \\ N \text{-} point \\ D F T \\ Matrix \\ \\ \\ \end{matrix} ] [ \begin{matrix}T & & & & & & & & \\ & R & & & & & & & \\ & & A & & & & & & \\ & & & N & & & & & \\ & & & & S & & & & \\ & & & & & F & & & \\ & & & & & & O & & \\ & & & & & & & R & \\ & & & & & & & & M\end{matrix} ] [ \begin{matrix} \\ \\ \\ N \text{-} point \\ I D F T \\ Matrix \\ \\ \\ \end{matrix} ] , \\ where & ( 10 ) \\ [ \begin{matrix}T \\ R \\ A \\ N \\ S \\ F \\ O \\ R \\ M\end{matrix} ] = [ \begin{matrix} \\ \\ \\ N \text{-} point \\ D F T \\ Matrix \\ \\ \\ \end{matrix} ] ( \begin{matrix}{P}_{1} \\ {P}_{2} \\ {P}_{3} \\ \\ ⋮ \\ ⋮ \\ \\ {P}_{N - 1} \\ {P}_{N}\end{matrix} ) . & ( 11 )\end{matrix}$$

When the conjugate of the pilot sequence signal values are used, the DFT and IDFT are interchanged and the TRANSFORM matrix values are conjugated. Thus, correlation with a matrix of conjugates of all cyclic pilot sequence shifts may be performed by Fourier transforming the received signal samples, weighting the transform results with the diagonal matrix TRANSFORM, then inverse transforming the result. If it is desired that the Fourier Transform of the received signal samples be the same Fourier Transform as used to decode OFDM symbols, and the latter is an IDFT, then the conjugate of the value TRANSFORM as defined above may be used.

Unfortunately, the DFT and IDFT of Equation (10) are not amenable to being performed using the Fast Fourier Transform when the length of the pilot sequence is one less than a power of two, and particularly when it is prime. However, if extended pilot sequences are used with an extended length equal to a power of two, then the same FFT used to process the received signal also serves as the first step in correlating with the pilot sequence shifts.

To continuously track the propagation channel, processor 260 may also compensate for the Doppler shift in individual propagation paths. For this embodiment, the correlator 240 may perform the correlating operation after applying one or more progressive phase rotations of the signal samples that remove a hypothesis of the Doppler shift. For example, if the Doppler shift of a particular delayed ray is believed to be between ±300 Hz, which represents a phase change of between ±21.60 over a 200 μs sample block duration, then a 1024-sample symbol may be phase rotated progressively by, for example, ±22.5/1024 degrees per sample, zero, and −22.5/1024 degrees per sample to determine which provides the best correlations for each delay. Alternatively, every 16-sample block may be rotated by 22.5/64 degrees progressively for successive symbols, or any other such variation thereof. By compensating for the Doppler shift on individual propagation path rays of different delay, the propagation channel may be tracked continuously from symbol to symbol. Indeed, the propagation channel may be estimated at any desired instant by correlating with a set of signal samples centered on the desired instant using the appropriate cyclic shifts of the pilot sequence.

The correlation of the received signal with the pilot sequence in correlator 240 preferably yields correlation values frequently enough to track changes in the propagation channel. In a wireless communication system, the propagation channel is expected to change due to Rayleigh fading, where the fading spectrum spans the range ±f_{d}, where f_{d} represents the maximum Doppler frequency. Channel estimator 250 therefore may comprise a low-pass filter that filters the correlation values with a filtering function centered at zero frequency and having a two-sided bandwidth of 2f_{d}. At 2 GHz, for example, and in a vehicle traveling at 70 mph or 110 kph, f_{d}=203.7 Hz, and the filter bandwidth would be 407.4 Hz. For a high speed train, such as the French SNCF TGV (Train Grande Vitesse), traveling at 300 kph, f_{d}=555 Hz, and the filter bandwidth would be approximately 1.2 kHz. If the information signal bandwidth is B (in kHz), then noise on the channel estimates caused by data may be reduced by the factor B/1.2, which may be termed “the processing gain.” More exactly, the amount of data noise that affects the channel estimates is equal to the ZFSD (Zero Frequency Spectral Density) of the information signal times the channel tracking filter noise bandwidth. In the GSM cellular system, for example, the ZFSD of the information signal is the same as if the data power were spread uniformly over 135 kHz. The processing gain is thus of the order of 10 log₁₀(135/1.2) or 20.5 dB. If the pilot sequence power is 10 dB less than the information signal power, the channel estimate-to-information signal-noise ratio is 10.5 dB. This ratio may not be adequate, so for use of this technique for a signal of GSM-like bandwidth at TGV-like speeds, a higher pilot power may be used, such as −6 dB relative to the information signal power. One advantage of the present invention is that the ratio of pilot energy to information signal energy may easily be varied by the transmitter 100 on a case-by-case basis, and/or dynamically, unlike the current GSM system where the number of pilot signal values is fixed in relation to the data symbols, and are of the same amplitude.

As already mentioned, the pilot sequence need not interfere with data decoding, as it is a known signal that may either be subtracted out or otherwise removed during processing, and a 1 dB loss of signal power due to devoting power to the pilot sequence may not be a concern in a land-mobile environment, which is not thermal noise limited. Other ratios of pilot to information signal power would be optimum for thermal noise limited environments, such as satellite communications.

The use of the channel estimates in an OFDM receiver differs somewhat from that of TDMA and CDMA systems that use the channel estimates to decode received signals. OFDM is generally considered for very wideband systems, where other means to handle a time-dispersive channel, such as Viterbi MLSE (Maximum Likelihood Sequence Estimation) equalizers, would be too complicated. OFDM has the characteristic that the Fourier transform of data at the transmitter 100 and subsequently at the receiver 200 converts time-dispersion, or Intersymbol Interference (ISI) between symbols transmitted successively in time, to signal level variations across the frequency domain and converts signal variation along the time domain, or Rayleigh fading, to ISI between symbols transmitted on successive frequency subcarriers. Signal level variations in the frequency domain in OFDM are also Rayleigh-distributed and are dealt with in the same way as signal variations in the time domain in other systems. That is, interleaving and error correction coding are used to address the signal level variations. ISI between different frequency carriers may be minimized by choosing short OFDM symbol lengths, over which the channel is substantially static.

Thus, channel estimates in a basic OFDM system are generally only used to provide a phase reference per subcarrier frequency for the detection of symbols modulated on the subcarrier frequency, and a sub-channel amplitude measure that provides correct soft information going into an error-correction decoder. Computing U*(n)Z(n) for each of the N subcarrier frequencies satisfies both goals, where n represents one of the N subcarrier frequencies, Z(n) represents the complex signal value in that sub-channel after the receive FFT, and U(n) represents an estimate of the phase and amplitude for that sub-channel.

Correlating the pilot sequence with the received signal does not produce the sub-channel phase and amplitude estimates U(n), but instead produces the channel estimates. However, a Fourier Transform relates the channel estimates to U(n). Thus, signal processor 260 may perform an FFT on a set of channel estimates, which are denoted by c₁, c₂, c₃, etc., to convert the channel estimates to a set of U(n) estimates, where the FFT is of the same type used on the OFDM symbol.

The signal processor 260 may also convert the channel estimates to U(n) estimates by the following alternative method. First, the signal processor 260 subtracts the known pilot sequence, weighted with the channel estimates, from the received signal to obtain a modified received signal, as shown in FIG. 14. Next, signal processor 260 passes the modified received signal though matched filter 232, which may comprise an FIR filter having coefficients equal to the conjugates of the channel estimates c₁, c₂, c₃, . . . , which are used in time-reversed order. Then, the signal processor 260 performs a weighted combination of the filtered samples using a pulse-shaping function as a weighting function. Lastly, signal processor 260 performs the receive FFT on the weighted and combined samples. The results directly contain the values U*(n)Z(n) in their respective sub-channels. That is, the results are already corrected for the phase of the sub-channel, and are of the correct relative amplitude to be used directly as soft symbols in an error correction decoding algorithm.

Other uses for wideband channel estimates in OFDM receivers may include antenna diversity combining, interference cancellation, and coherent macro-diversity. The coherent macro-diversity may be carried out as already described for CDMA systems in the following U.S. patents to Applicant: 7,224,942 titled “Communications system using non-polluting pilot codes,” titled 7,209,511 “Interference Cancellation in a CDMA receiving system,” titled 7,197,282 “Mobile Station Loopback processing,” titled 6,996,380 “Communications system employing Transmit Macrodiversity,” and titled 6,996,375 “Transmit diversity and separating multiple loopback signals. While it is believed that using the channel estimates as disclosed in the above patents may be readily adapted to OFDM systems using pilot sequences or other means to provide full, wideband channel information, it is beyond the scope of this disclosure to elaborate further on those subjects.

If the relationship of the pilot sequence to the OFDM symbol is known by virtue of the timing options described above, e.g., cyclic rotation of the pilot sequence, overlap of OFDM symbols, alignment of the OFDM symbols with the pilot sequence, etc., the channel estimation process may also be used to obtain the OFDM symbol timing. For example, a one-symbol mismatch between the length of an OFDM symbol and the length of the pilot sequence means the timing of the pilot sequence will slide relative to the information signal by one signal value per symbol and return to the original timing after 1023 symbols. When the cyclic rotations option is used, the coarse system timing may be provided so that the receiver 200 knows the symbol number (between 0 and 1023) in the current frame. Conventional systems, such as GSM and UMTS provide examples and solutions for the acquisition of coarse system timing by listening to and decoding a synchronization channel at start-up to determine which one of symbols 1 to 1023 is currently being processed, so that the correlator 240 may use the appropriate cyclic rotation of the pilot sequence for the correlation process.

While not required, pulse-shaped OFDM may also be used with the present invention. Pulse-shaped OFDM cyclically repeats DFT output samples, where the repeats and pre-peats are gradually weighted to zero with a tapering function, thereby forming one Pulse-Shaped OFDM pulse. A sequence of Pulse-Shaped OFDM pulses are usually additively combined with each other with a time-shift of exactly one DFT sample block period, or 1024 samples in this example. The pulse-shape may be chosen to have the Nyquist property in both the time and frequency domain so that different frequency subcarriers within the same OFDM pulse are non-interfering, and same-frequency subcarriers in different OFDM pulses are non-interfering. Diagonal ISI may remain, whereby one frequency subcarrier in one OFDM pulse has a non zero coupling with a different frequency subcarrier in a different OFDM pulse. Doubly-Nyquist pulse-shapes and means to handle diagonal ISI are further described respectively in U.S. patent application Ser. Nos. 12/126,576 and 12/045,157 to current Applicant.

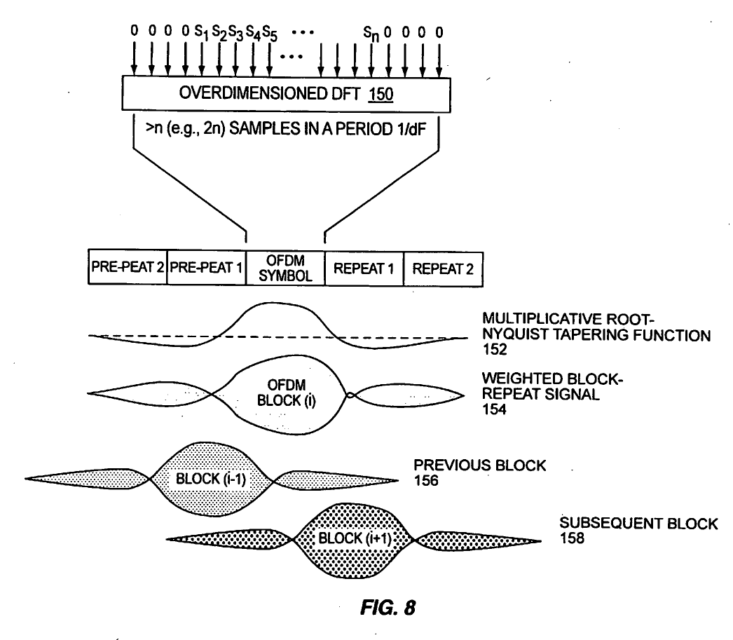

FIG. 8 shows practical details of a pulse-shaped OFDM signal generated when DFT unit 126 comprises an over-dimensioned DFT unit 150. The output OFDM symbol from DFT unit 150 is repeated both before (as “pre-peat 1” and “pre-peat 2”) and after (as repeat 1 and repeat 2). The repeated sample blocks are tapered smoothly to zero amplitude at the ends by multiplication with tapering function 152 to generate a weighted repeat signal 154. Tapering function 152 preferably has the root-Nyquist property in both time and frequency.

Weighted repeat signal 154 is additively combined with similar weighted repeat signals 156, 158 derived from earlier and subsequent OFDM symbols. The length of each weighted repeat signal 154, 156, 158 determines how many repeat signals overlap before they taper to zero, and is not limited to the three used in illustration in FIG. 8. As already mentioned above, the repeat signals 154, 156, 158 may be combined with a shift of one whole symbol, or alternatively with a shift of one whole symbol minus one pilot sequence signal value. If the over-dimensioning factor of the DFT unit 150 is a factor of two, one pilot sequence signal value will correspond in duration to two samples output by DFT 150. Thus, for this embodiment, combiners 130 linearly add successive waveforms to a relative shift of 2N−2 pilot signal values.

Combiner(s) 130 linearly adds a pilot sequence, such as an MLS, to the pulse-shaped OFDM signal in the digital domain. The MLS has 2^{l}−1 signal values, which is one short of the typically 2^{l} samples in an OFDM symbol. The MLS may thus be added one signal value per OFDM sample, and the mismatch of one in the length handled in any of the optional ways discussed above. FIG. 9 shows the combined weighted repeat signals 154, 156, 158, which now comprise a serial stream of complex samples D_{I}, D_{Q}, added in a complex added 130 to a serial stream of signal values from cyclically repeated pilot sequences. The complex signal T_{I}, T_{Q} output by complex adder 130 comprise the OFDM information signal linearly added to the pilot sequence, both of which may be oversampled at 2 samples per Hz. The oversampled pilot sequence comprises 2046 samples if a non-extended MLS of 1023 signal values was employed, or may comprise 2048 samples if an extended MLS of 1024 signal values was employed.

The oversampled pilot sequence may be generated in advance and stored offline. For example, if successive OFDM symbols are overlapped in order to correspond to the length of a non-extended pilot sequence, then the 1023-signal value pilot sequence is input to a 1023-point DFT. Let the convention of this DFT be that output sample 512 corresponds to the zero-frequency component so that the negative frequency components correspond to samples 1 to 511 and positive frequency components correspond to samples 513 to 1023. The output samples may be placed in the middle of an array of 2046 spectral components, with index 1024 representing zero frequency. The extra inputs indexed 1 to 512 and 1536 to 2046 are set to zero. The double size spectral array is then subjected to a 2046-point IDFT to obtain the 2:1 oversampled pilot sequence of 2046 signal values. The result may be stored for repetitive use in addition with the OFDM signal samples in adders 130.

If instead of overlapping successive OFDM symbols by one sample, the pilot sequence is extended to have the same length as the OFDM symbol, e.g., 1024 signal values, then the above procedure may be used with slight modifications. In particular, the pilot sequence has 1024 signal values, the first DFT is a 1024-point FFT, and the 2046-point IDFT is changed to a 2048-point IFFT.

If the pilot sequence is 1023 signal values long and the OFDM symbols are 1024 samples long, with sliding relative phase, a 2046-value oversampled pilot sequence is pre-computed according to the above procedure. Then, 2:1 oversampling of the OFDM data symbols is performed using a 2048-point 2:1 over-dimensioned FFT. The 2046-value pilot sequence is then added to successive 2046 OFDM symbols, with the relative symbol alignment sliding 2 samples each time. There are thus two options for estimating the timing of the pilot sequence signal values relative to the OFDM samples. In a first option, the center of a pilot sequence signal value aligns with the center of an OFDM sample. In a second option, the center of a pilot sequence signal value aligns half a value out (e.g., one sample at 2:1 oversampling). Either option may be used as long as the transmitter 100 and receiver 200 agree upon the selected option in advance.

The baseband processor 120 does not necessarily apply the same OFDM symbol pulse-shaping to the pilot sequence. The out-of-band spectral roll-off of the pilot sequence will then tend to equal the frequency response of any transmitter anti-aliasing filter 142, while the spectrum of the pulse-shaped OFDM symbol rolls off more sharply, in accordance with the Fourier Transform of the pulse-shaping function. If, on the other hand, repeats and pre-peats for the cyclic pilot sequence are weighted and combined as for the OFDM signal, then their spectra would be the same. There are many aspects that might favor one approach over the other, depending on the purpose for which the pilot sequence-based channel estimates generated at the receiver 200 are to be used by the receiver 200. Examples of both are described below. Either may be used, depending on these other purposes, and are both considered to fall within the scope and spirit of the present invention claimed herein.

Receiver 200 collects, weights, and adds the shaped repeats of each OFDM symbol using the same shaping function used by transmitter 100. Because the pulse-shaping function used by both the transmitter 100 and receiver 200 are root-Nyquist, receiver 200 will produce overall Nyquist shaping, which has the property that the other overlapping OFDM symbols are substantially cancelled, avoiding symbol-to-symbol interference. However, using such matched filtering is not appropriate for the pilot sequence repeats, if they are not pulse shaped, before they are used for channel estimation. Therefore, channel estimation at receiver 200 may be carried out first, before weighted combining of symbol repeats. The receiver 200 thus performs only filtering matched to the transmitter anti-aliasing filters 142, which may appropriately also be root-Nyquist, and then performs correlation with the pilot sequence to determine the multi-path propagation channel. An advantage of knowing the propagation channel before combining repeats of the OFDM symbol is that any phase or amplitude change from symbol to symbol caused by dynamic changes to the propagation channel may be corrected before combining. For example, each OFDM symbol may be subjected to a filter matched to the channel before the receiver 200 performs weighted combining of the symbol with weights matched to the pulse-shaping function. Channel-matched filtering generally uses an FIR filter with coefficients that are the time-reversed conjugates of the channel estimates. Moreover, knowing the channel estimates early allows the pilot sequence interference with the data to be subtracted out before combining block-repeats.

It is theoretically possible to use pulse-shaped OFDM in a non-contiguous spectrum, or even to excise sub-channels or groups of sub-channels on a fine grid to avoid frequencies used by other services or signals. In order to use the method of adding a pilot sequence to an OFDM symbol in a non-contiguous spectrum, the following method may be used. The OFDM symbol may be divided into multiple sample sub-blocks, each comprising one sample for each of n(k) subcarrier frequencies covering a sub-band spectrum k of the overall OFDM spectrum. A length-k pilot sequence may be added to the OFDM sample sub-block. Thus, each sample sub-block is treated in its own right as an OFDM symbol having its own superimposed pilot sequence.

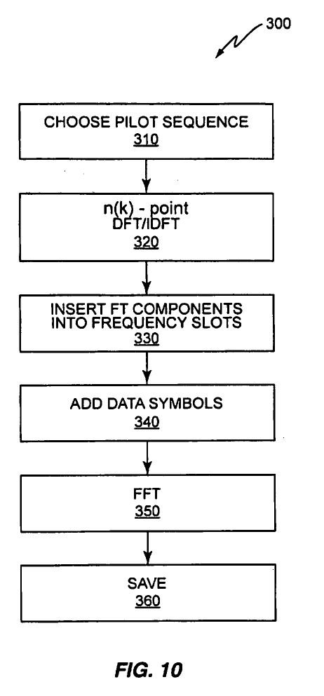

If n(k) is not a power of two, then a PRN other than an MLS is chosen for the pilot sequences. Fortunately, as such non-contiguous systems are generally based on using the same subcarrier frequency spacing in each OFDM sample sub-block, the time-duration or period of each pilot sequence is the same for each frequency sub-band. In fact, the non-contiguous OFDM signal is generated by simply setting symbols to zero in an OFDM system covering the entire spectrum contiguously, using one large FFT. Thus, the method 300 shown in FIG. 10 may be used to generate a pilot sequence signal for all sub-bands. First, for each sub-band, choose a pilot sequence having n(k) signal values corresponding to the n(k) subcarrier frequencies in the sub-band k (block 310). The pilot sequence preferably has a good autocorrelation function with cyclic rotations of itself, e.g., as near a Dirac-function as possible. Next, perform a Fourier Transform of the n(k) signal values of the pilot sequence using an n(k)-point DFT/IDFT (block 320). Then, insert the Fourier Transform components into the correct subcarrier frequency slots used by the associated sub-band of one large FFT, of the same size as the FFT used to create the OFDM symbol (block 330). Next, add the data symbols to the DFT/IDFT components of the pilot sequences at the input of the main (larger) FFT (block 340) and perform the larger FFT on the sum (block 350). Finally, save the result for combining with previous and subsequent sample sub-blocks using the pulse-shaping weighting function (block 360). The final step shows that the pilot sequences now get pulse-shaped in the same way as the OFDM symbol. Thus, the spectra of the pilot sequences and the OFDM symbol are identical and do not violate the “no-go” bands that were excised to form non-spectrally-contiguous OFDM.

Yet another modification of the above method is to realize that the pilot sequences chosen in block 310 of method 300 may be selected to have a Dirac auto-correlation function that obtain a flat or “white” spectrum over each sub-band. However, this goal may be directly achieved by choosing the Fourier Transform components of the pilot sequence to be of equal amplitude. The phases of these components may be chosen to minimize the peak amplitude of the time-waveform. For example, they would not all be chosen to be in phase, as that results in an impulse-like time function with a high peak value, which may cause the transmitter 100 to clip. The difference between this method of inserting pilot signal values into the signal spectrum, and the known method of inserting pilot signal values in place of data samples, is that the pilot signal values proposed herein are added to the data samples, and therefore, do not take on or replace the data samples. Thus, it is not necessary to avoid transmitting data in certain subcarrier frequency slots in order to accommodate pilot signal values. Further, the number of pilot signal values is not limited by the need to avoid consuming too much of the data capacity. Instead, both the data samples and pilot signal co-exist in each subcarrier frequency slot.

In the case of non-contiguous OFDM, no assumption may be made about the nature or strength of other signals in between the occupied sub-bands. Therefore, receiver 200 excises energy in unused subcarriers between the sub-bands before any further processing. To excise the unused subcarriers, receiver 200 performs matched filtering using the OFDM pulse-shaping function to combine successive OFDM symbols, FFTs the combined result, and sets to zero the FFT output bins corresponding to unused sub-channels. In principle, the result may then be returned to the time domain and successive samples so-obtained recombined using the pulse-shaping function in an attempt to reproduce the signal received before processing but with the interfering signals in the unused subcarrier frequencies having been removed. In this case, however, combining block-repeats using the pulse-shaping function as a matched filter does not benefit from early knowledge of the channel, as was described for contiguous OFDM. Nevertheless, correlating the reconstituted received signal with a time-domain version of the inserted pilot signal values may be attempted in order to retrospectively obtain early channel estimates. The latter may then be used to repeat matched filtering using the pulse-shaping function after compensating for the channel estimates so-obtained, thus forming a multi-pass processing system in which successive refinements of the signals are expected to converge.

To this point, the invention has been described in terms of a single pilot sequence added to both the I and Q portions of the OFDM samples. However, two different pilot sequences may be used, where one pilot sequence is added to D_{I}, and the other pilot sequence is added to D_{Q}. Using two different pilot sequences may be viewed as adding one of the QPSK symbols (1+j), (1−j), (−1+j), and (−1−j) to the DFT output. Adding such QPSK symbols to the DFT output may be viewed as rotations of the real value √2 through angles of +45, 45, +135 or −135°. Channel estimation at the receiver 200 may then comprise de-rotating the received sample values by these known angles to align them all to the real axis, and adding the results. The resulting complex number gives the phase and amplitude of the propagation channel for one delay hypothesis. Repeating the procedure with a delay between the angle sequence and the received sequence yields channel phase and amplitude for a different delay hypothesis.

Cyclically repeated pilot sequences of other lengths, for example 511 or 255 may also be used. Use of length-511 sequences superimposed on an OFDM symbol comprising 1024 samples simply means that channel estimation is obtained by correlating with two sets of 511 signal values, which may be done by first combining signal values in sets of 511 and then performing a length 511 correlation, using a 512-point Fast Walsh Transform to correlate with all pilot sequence shifts, if needed. In the case of a length 511 pilot sequence, the alignment of the two sets of 511 signal values with the 1024 FFT samples will repeat every 511 sample blocks, or ˜100 ms in the case of 200 μs symbol lengths.

Data interference with pilot correlation reduces with lower mobile device speed or higher data bandwidth. An issue that arises with high data speeds using direct modulation of the wireless carrier frequency with a high speed data symbol stream is that ISI due to delayed multi-path spans a greater number of symbols, making the received data harder to decode. Typically, the complexity of a Viterbi MLSE multi-path equalizer increases exponentially with the multi-path delay spread. In a satellite communications system where the signal is received from above, rather than at grazing incidence to the ground clutter, multi-path delay spread is small and the data rate may therefore be increased. Thus, one suitable application of the present invention would be to construct wider bandwidth signals for satellite communications services, particularly for broadcast services, such as those provided by XM-radio and Sirius satellites. Those services utilize two-satellite diversity transmissions to obtain the quality and fading mitigation required for broadcast services such as music entertainment. Today, the diversity transmissions use separate frequencies for each satellite, but spectral efficiency would be improved if same-frequency diversity could be employed in the future. Diversity demodulators such as described in PCT Application Serial No. PCT/SE2008/050286 titled “Same-Frequency Satellite Ground Radio Broadcast” to current Applicant may be used to decode such signals, which are characterized by a large differential delay between the two satellite signals of between +5 ms, as well as a differential Doppler shift of between approximately ±100 Hz. For efficiency, a diversity-decoded data sample block has a size or duration many times the differential delay, and thus on the order of 50 ms or more. Therefore, the propagation channel phase from the two satellites may change in opposite directions and through many multiples of 2π in the sample block period, necessitating continuous channel estimation. The present invention is particularly suited to the provision of continuous channel estimation for such diversity signals, as discussed herein.

Returning to the land-mobile scenario, there is a trend towards higher data rates and broadcast services that would also benefit from the current invention. In a terrestrial environment having a significant delay spread, current proposals utilize OFDM for high speed data, which is believed to better survive the high delay spread. As discussed above, OFDM comprises transmitting the Fourier Transform of data symbols instead of transmitting the data symbols directly, and is similar to dividing a high speed data stream into a plurality of lower speed data streams spread across the frequency spectrum.

The effect of a Fourier Transform before transmission and an inverse Fourier Transform upon reception is to convert the delay spread to a Rayleigh distribution of symbol amplitudes across the frequency spectrum, and conversely to convert Rayleigh signal variations in the time domain to ISI between symbols on different sub-channels. The former may, however, be handled by the use of error correction coding across symbols along the frequency domain, while the latter may be minimized by choosing short sample block lengths over which the channel is expected to be reasonably static. Nevertheless, OFDM requires channel information sufficient to characterize the channel phase for each sub-channel across the frequency spectrum and over time. Conventional methods for providing such channel information are quite complicated. Typically, conventional methods involve allocating selected OFDM data symbols distributed in certain patterns across the frequency and time domain to be pilot symbols, and performing a two-dimensional interpolation of the channel knowledge thereby gained at the selected points in order to determine the channel at other frequency/time points. Interpolation of the channel becomes more difficult as the delay spread increases because the propagation channel may not be coherent over more than 40 kHz, or four 10 kHz sub-channels, requiring every 4^{th} symbol or 25% of the total OFDM symbol capacity to be given over to pilot symbols.

The present invention provides a better way to characterize the propagation channel for wideband OFDM signals, as it provides complete channel information on a continuous basis without having to waste OFDM symbol capacity in providing pilot symbols. For OFDM signals having a 5 MHz bandwidth, the processing gain reduction of data noise on channel estimates is 36 dB even at TGV speeds, giving 26 dB channel estimate SNR when the power of the pilot sequence is 10% of the OFDM data signal power.

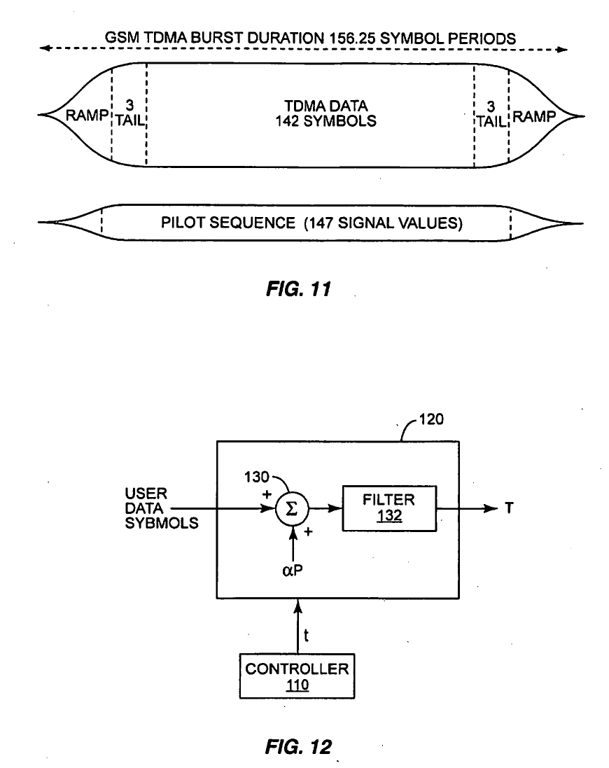

The present invention may also be applied to TDMA systems. FIG. 11 shows a TDMA burst of data symbols overlapping a pilot sequence. For this example, the data symbols of the TDMA burst may be ramped up and down at the beginning and end, respectively, to smoothly truncate the burst. The pilot sequence comprises an extended pilot sequence of 127 signal values plus a cyclic postfix (e.g., the first 20 signal values repeated at the end) or a cyclic prefix (e.g., the last 20 signal values repeated at the beginning). The cyclic prefix guarantees that all 127 signal values of the pilot sequence are present in any time shift of the signal by an amount of 0 to 20 signal values. The end signal values of the pilot sequence may be ramped up and down like the TDMA burst.

FIG. 12 shows one exemplary TDMA baseband processor 120 for transmitter 100. Baseband processor 120 comprises a combiner 130 and a filter 132. Combiner 130 linearly adds the weighted pilot sequence to the user data symbols. Filter 132 commonly filters the combined symbols using the filtering specified by the communication standard, e.g., the filtering specified in the GSM standard for the linear, EDGE mode, to generate the combined signal T. Baseband processor 120 chooses the weighting factor α to set the amplitude of the pilot sequence in relation to the amplitude of the data symbols to give the best compromise between diverting signal energy from the data symbols to the pilot sequence and providing improved channel estimation at the receiver 200. The controller 110 identifies the transmission time slot t used to transmit the combined signal.

At receiver 200, the correlator 240 correlates the received symbols with different cyclic rotations of the pilot sequence, or alternatively correlates the pilot sequence with different shifts of the received symbols, as described above. The resulting channel estimates determine how much of each pilot sequence shift is present on the received data and its phase. Therefore, receiver 200 has all of the information necessary to remove the pilot sequence from the data signal, e.g., by subtraction.

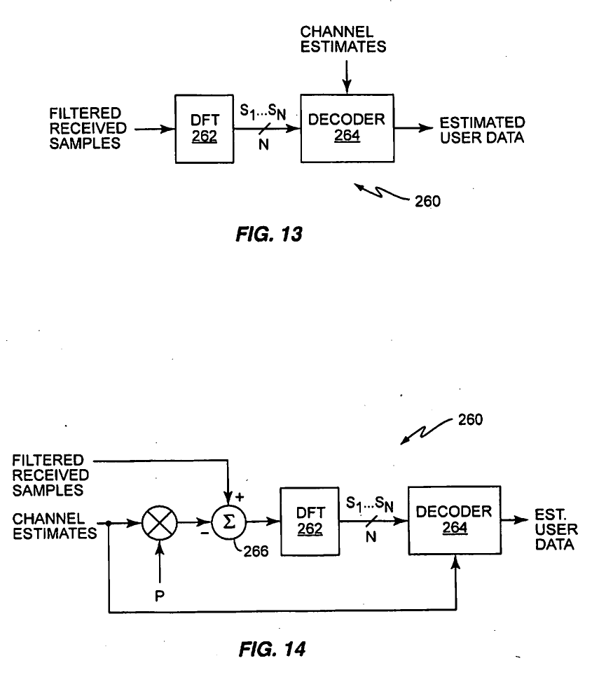

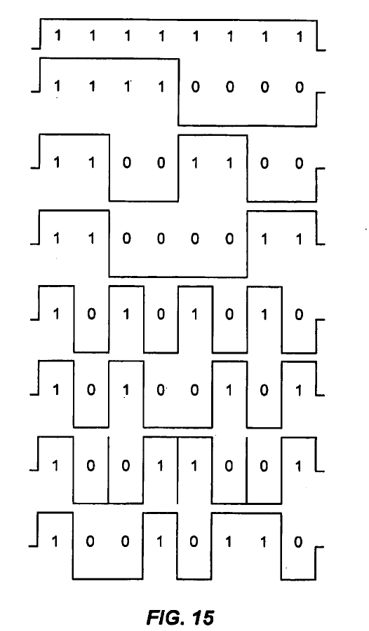

Signal processor 260 processes the received symbols to remove the pilot sequence from the data symbols. As shown in FIGS. 14 and 15, signal processor 260 comprises a DFT unit 262 and a user data decoder 264. DFT unit 262 operates on the filtered samples output by the matched filter 232 to divide the received signal into subcarrier values. The user data decoder 264 uses the channel estimates as a phase reference to decode the subcarrier values which are modulated with the user data symbols. Decoder 264 may also perform soft error correction using the channel estimate amplitudes to indicate the reliability of a decoded subcarrier values. In one embodiment, decoder 264 removes the pilot sequence from the desired information signal while decoding the subcarrier values, as shown in FIG. 13. In another embodiment, a combiner 266 subtracts the pilot sequence, as modified by the channel estimates, from the subcarrier values before processing by the decoder 264, as shown in FIG. 14.

In some embodiments, a Viterbi MLSE equalizer algorithm may be used while decoding the data symbols to simultaneously remove the pilot sequence. GSM receivers generally employ one or other variant of the Viterbi MLSE algorithm, further developed for demodulating signals subject to multi-path distortion by Proakis, Formey, Ungerboeck and others. The Viterbi MLSE algorithm is described, for example, in “Digital Communications” by J. G. Proakis, Mcgraw-Hill, New York 1989. The principle of the Viterbi MLSE equalizer is to hypothesize data symbol sequences and to predict signal samples that should be received using the estimates of the propagation channel provided by channel estimator 250. Then a comparison is made between the actually received signal samples and the predicted signal samples to determine a mismatch error. The modulus squared of the mismatch error is added to a cumulative penalty measure, or metric, for the hypothesized sequences. The hypothesized sequence that accumulates the smallest penalty metric at the end of the decoding process represents the most likely user data.

A key feature of the Viterbi MLSE algorithm is that the number of hypotheses that are retained at any point during decoding is only H^{j-1}, where H is the size of the data symbol alphabet and j is the number of symbol periods of delay between the earliest and latest multi-path ray. Thus, the process of computing a penalty metric comprises calculating the mismatch error δ according to:

δ=R(i)−[c₁d(i)+c₂d(i−1)+c₃d(i−2) . . . ] (12)

where c₁, c₂, c₃ . . . comprise the channel estimates and . . . d(i−2), d(i−1), d(i) comprises the sequence of data symbol hypotheses. Adding the square of the current penalty metric to the penalty metric calculated for previous hypothesis sequences ending in the same values of d(i−1) and d(i−2) before appending the new data symbol d(i) provides the penalty metric for the sequence ending in d(i−2), d(i−1), d(i). If d(i−3) is not needed to predict R(i), then the best over all possible values of d(i−3) of all sequences having the same values of d(i−1) and d(i−2) is selected, which prunes the number of hypotheses to a constant value after each iteration.

For TDMA, the transmitted signal value may be given by d(i)+γp(i), d (i−1)+γp(i−1), d(i−2)+γp(i−2), etc., where γ represents the chosen ratio between the amplitude of the pilot sequence signal values p(i−2), p(i−1), p(i) and the amplitude of the data symbols d(i−2), d(i−1), d(i). Thus, computing the mismatch error δ according to:

δ=R(i)−[c₁(d(i)+αp(i))+c₂(d(i−1)+αp(i−1))+c₃(d(i−2)+αp(i−2)) . . . ] (13)

gives the same result as if the pilot sequence contribution, e.g., c₁αp(i), had been subtracted from the received signal data first.

In another embodiment, the receiver 200 may exploit the benefits of adding pilot signal values to hypothesized data symbols. For example, the fact that the data symbols and pilot signal values are generally composed of 1's and 0's allows the number of multiplication operations to be reduced. Further, the number of different combinations of data symbols and pilot signal values is limited, which allows all linear combinations of the data symbols plus the pilot signal values with channel estimates to be pre-computed in an efficient, Grey-coded order, in which only one symbol at a time changes in value. In addition, if the channel estimates are refined by sequentially updating them during decoding, then the accuracy of the pilot subtraction improves with the refined channel estimates.

Typically, channel estimates are updated by at least an estimate of the frequency error, which would otherwise cause mismatch due to phase rotation. Channel estimates may also be updated using the received signal with a just decoded data symbol removed, thus leading to progressively improved channel estimates that do not suffer from the data noise as decoding progresses. If desired, each TDMA burst may also be decoded again, starting with the improved channel estimates obtained after the first decoding. Such two-pass decoding has been used for other reasons in the past, and may be useful if TDMA systems evolve to use higher order signal constellations, such as 64 QAM, which may require more accurate channel estimates for proper decoding. Also, successive refinements in parameters such as frequency error or channel estimates may be done on a per-Viterbi-state basis. For example, U.S. Pat. No. 5,136,616 to Applicant describes per-state automatic frequency control, U.S. Pat. No. 5,646,963 describes per state automatic gain control, and U.S. Pat. No. 5,164,961 discloses per-state channel estimation. In the '961 patent, just-decoded data symbols are assumed to be correct and thus may be regarded as an extension of a known pilot sequence, allowing improved channel estimation. By contrast, the method described herein assumes that a just-decoded data symbol would be subtracted from the received signal, leaving only the known pilot signal values, which allows improved channel estimation by virtue of the elimination of interference from the data symbol. However, both methods may be combined, such that a just decoded data symbol is assumed to be correct and thus, together with the known pilot symbol, the receiver 200 knows everything on which the received signal depends, which permits improved channel estimation.

Signal impairments to the data samples other than that caused by the presence of a pilot sequence may also be simultaneously removed by an MSLE decoding algorithm. For example, a DC offset in the received signals caused by using a Homodyne receiver may be removed by estimating it from known pilot signal values, as suggested in U.S. Pat. No. 5,241,702 to current Applicant and further elaborated by Lindoff in U.S. Pat. No. 6,449,320 titled “Equalization with DC offset compensation.” The DC offset initially estimated with pilot signal values may also be refined during progression of data decoding within the MLSE algorithm.

The present invention may also be applied to CDMA systems. FIG. 15 shows a set of mutually orthogonal Walsh-Hadamard spreading codes, as may be used in CDMA cellular systems, such as the 3G system known as UMTS or WCDMA, and in the 2G system known as IS95. The first code at the top of FIG. 15, named Walsh Code Zero, comprises a string of eight like chips, which are shown as binary 1's, but may equally well have been binary zeros. Each of the eight spreading codes is orthogonal to the other seven. This property is guaranteed because when comparing any pair, half of the chips are the same and half are different. Further, this property is conserved if all the spreading codes are multiplied alike by any other chip pattern.

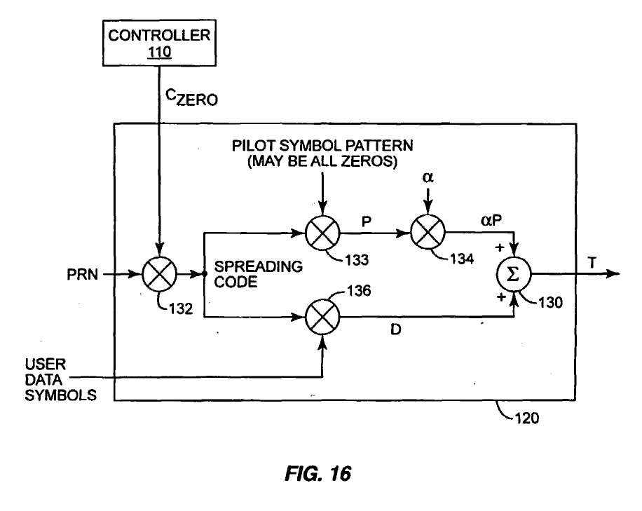

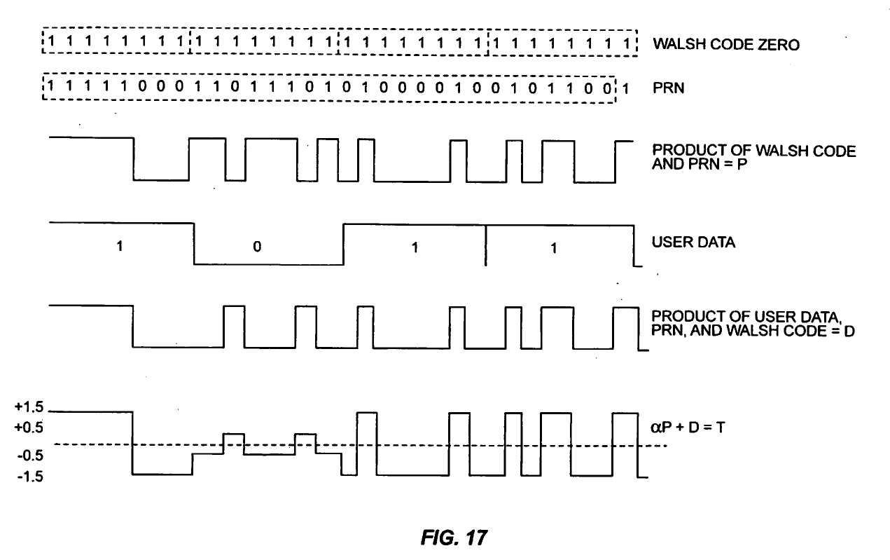

FIG. 16 shows an exemplary CDMA baseband processor 120 for transmitter 100, while FIG. 17 shows corresponding signals in the CDMA processor 120. Multiplier 132 combines Walsh Code Zero C_{zero} from a 32-bit Walsh-code set with a repetitive 31-bit PRN to form a spreading code, which may be used as the pilot sequence P. Alternatively, as shown in FIG. 16, the pilot sequence P may be generated by further multiplying the spreading code with a pilot symbol pattern in multiplier 133 to further randomize the pilot sequence. The pilot symbol pattern may comprise a user-data rate symbol pattern. However, further randomization using the pilot symbol pattern is not necessary, as the PRN is generally sufficiently random. Thus, the example of FIG. 16 is simplified by choosing the pilot symbol pattern to be all zeros (or ones) such that the pilot sequence P equals the raw spreading code before combination with the user data symbols. It shall be understood that the other seven Walsh Codes of FIG. 15 are also combined with the same PRN so as to conserve their mutual orthogonality. In the prior art, Walsh Code Zero combined with the PRN would form a pilot sequence only, and Walsh code Zero would not be expected to carry user data. Thus, one out of eight of the spreading code resources was consumed by the pilot sequence, leaving only seven spreading codes for user data. FIG. 17 illustrates the combination of Walsh code zero and the PRN when also linearly combined in combiner 130 with a sequence of data symbols to produce a combined signal T. The final signal at the bottom of FIG. 17 shows the results of the linear combination of the user data with a pilot sequence, where γ=0.5. This signal may be correlated with the pilot sequence over a sufficiently large number of data bits to estimate the propagation channel. Then receiver 200 may reconstruct the known pilot sequence, influenced by the just-determined propagation channel characteristics, and subtract it from the received signal to provide user data free of pilot sequence interference for decoding. Thus, the same orthogonal spreading code may be used to carry both a pilot sequence and user data.

Thus, it has been disclosed how using the same multiplexed radio resource may be used to transmit a pilot sequence and user data to a receiver 200 without reducing the radio resources available for user traffic. For example, a communications satellite operating over an assigned bandwidth B may transmit a single, high bit pilot sequence covering the bandwidth B on top of any and all other data communications signals transmitted within the same bandwidth B. Such data communications signals may include FDMA, CDMA, TDMA, and OFDM signals. For this example, each receiver 200 uses the one pilot sequence to estimate the complete wideband channel. The estimated wideband channel is convertible to channel information pertinent to the individual signals using different sub-bands, and may also be used to properly weight the known pilot sequence so that its interference with data transmission may be removed. In principle also, a GSM system operating in say 50, 200 kHz channels in a total bandwidth of 10 MHz may radiate a single, 10 megabit per second PRN sequence or MLS in order to provide fine-grained channel information for every 200 kHz channel.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of communicating information over a propagation channel between a transmitter and a receiver comprising:
transmitting an information signal using a multiplexed radio resource; and
simultaneously transmitting a pilot sequence using the same multiplexed radio resource.

2. The method of claim 1 wherein simultaneously transmitting the pilot sequence and the information signal using the same multiplexed radio resource comprises simultaneously transmitting the pilot sequence and the information signal in a CDMA network using the same orthogonal spreading code.

3. The method of claim 2 wherein transmitting the pilot sequence and the information signal using the same orthogonal spreading code comprises:
spreading the pilot sequence and the information signal with the same orthogonal spreading code; and
linearly combining the spread pilot sequence with the spread information signal to generate a combined signal; and
transmitting the combined signal.

4. The method of claim 1 wherein simultaneously transmitting the pilot sequence and the information signal using the same multiplexed radio resource comprises transmitting in a TDMA network the pilot sequence and the information signal overlapping the same symbol periods within an allocated timeslot.

5. The method of claim 4 wherein transmitting the pilot sequence and the information signal using the same symbol periods within an allocated time comprises:
linearly combining the pilot sequence with the information signal to generate a combined signal; and
transmitting the combined signal during the allocated time slot.

6. The method of claim 1 wherein simultaneously transmitting the pilot sequence and the information signal using the same multiplexed radio resource comprises simultaneously transmitting the pilot sequence and the information signal in an OFDM network using the same set of subcarrier frequencies during the same OFDM symbol block period.

7. The method of claim 6 wherein transmitting the pilot sequence and the information signal using the same set of subcarrier frequencies comprises:
dividing user data bits into n parallel bit streams;
modulating each one of the n parallel bit streams onto a respective one of the n subcarrier frequencies to generate the information signal;
linearly combining the pilot sequence with the information signal to generate a combined signal; and
transmitting the combined signal.

8. The method of claim 1 wherein the pilot sequence comprises a pseudorandom sequence.

9. The method of claim 1 wherein the length of the pilot sequence is less than the block length of the information signal.

10. The method of claim 9 further comprising padding the pilot sequence by one or more samples to increase the length of the pilot sequence to that of the information signal.

11. The method of claim 9 further comprising overlapping successive information signals by one or more samples to align the block length of the information signal with the length of the pilot sequence.

12. The method of claim 9 further comprising aligning successive information signals with cyclic rotations of the pilot sequence.

13. The method of claim 1 wherein a ratio of a pilot sequence power to an information signal power is less than unity.

14. The method of claim 13 further comprising dynamically varying the ratio of the pilot sequence power to the information signal power.

15. A wireless device for communicating information over a propagation channel comprising a transmitter configured to simultaneously transmit a pilot sequence and an information signal using the same multiplexed radio resource.

16. The wireless device of claim 15 wherein the transmitter is part of a CDMA network, and wherein the transmitter simultaneously transmits the pilot sequence and the information signal using the same multiplexed radio resource by simultaneously transmitting the pilot sequence and the information signal using the same orthogonal spreading code.

17. The wireless device of claim 16 wherein the transmitter comprises:
a spreading unit to spread the pilot sequence and the information signal with the same orthogonal spreading code; and
a combiner to linearly combine the spread pilot sequence with the spread information signal to generate a combined signal; and
a transmitting unit to transmit the combined signal.

18. The wireless device of claim 15 wherein the transmitter is part of a TDMA network, and wherein the transmitter transmits the pilot sequence and the information signal using the same multiplexed radio resource by transmitting the pilot sequence overlapping the information signal using the same symbol periods of the allocated time slot.

19. The wireless device of claim 18 wherein the transmitter comprises:
a combiner to linearly combine the pilot sequence with the information signal to generate a combined signal; and
a transmitting unit to transmit the combined signal during the allocated time slot.

20. The wireless device of claim 15 wherein the transmitter is part of an OFDM network, and wherein the transmitter simultaneously transmits the pilot sequence and the information signal using the same multiplexed radio resource by simultaneously transmitting the pilot sequence and the information signal using the same set of subcarrier frequencies during the same OFDM symbol block period.

21. The wireless device of claim 20 wherein the transmitter comprises:
a serial to parallel converter to divide user data bits into n parallel bit streams;
a plurality of modulators, each modulator to modulate one of the n parallel bit streams onto one of n subcarrier frequencies to generate the information signal;
a combiner to linearly combine the pilot sequence with the information signal to generate a combined signal; and
a transmitting unit to transmit the combined signal.

22. The wireless device of claim 15 wherein the pilot sequence comprises a pseudorandom sequence.

23. The wireless device of claim 15 wherein the length of the pilot sequence is less than the block length of the information signal.

24. The wireless device of claim 23 wherein the transmitter is further configured to pad the pilot sequence by one or more samples to increase the length of the pilot sequence to that of block length of the information signal.

25. The wireless device of claim 23 wherein the transmitter is further configured to overlap successive information signals by one or more samples to align the block length of the information signal with the length of the pilot sequence.

26. The wireless device of claim 23 wherein the transmitter is further configured to align successive information signals with cyclic rotations of the pilot sequence.

27. The wireless device of claim 15 wherein a ratio of a pilot sequence power to an information signal power is less than unity.

28. The wireless device of claim 26 wherein the transmitter is further configured to dynamically vary the ratio of the pilot sequence power to the information signal power.

29. A method of processing a signal received at a receiver, wherein the received signal comprises a linear combination of a known pilot sequence and an information signal transmitted over a propagation channel using the same multiplexed radio resource, the method comprising:
correlating the received signal with the known pilot sequence to determine one or more correlation values;
determining channel estimates for the propagation channel based on the one or more correlation values; and
processing the received signal using the determined channel estimates to remove the pilot sequence from the information signal.

30. The method of claim 29 wherein the receiver comprises a CDMA receiver, and wherein the pilot sequence and the information signal were transmitted using the same orthogonal spreading code.

31. The method of claim 29 wherein the receiver comprises a TDMA receiver, and wherein the pilot sequence and the information signal overlap the same symbol periods within an allocated time slot.

32. The method of claim 29 wherein the receiver comprises an OFDM receiver, and wherein the pilot sequence and the information signal were transmitted using the same set of subcarrier frequencies during the same OFDM symbol block period.

33. The method of claim 29 wherein correlating the received signal with the known pilot sequence comprises correlating the received signal with multiple time shifts of the known pilot sequence.

34. The method of claim 29 wherein correlating the received signal with the known pilot sequence comprises correlating multiple time shifts of the received signal with the known pilot sequence.

35. The method of claim 29 further comprising applying one or more progressive phase rotations to samples of the received signal to remove an hypothesized Doppler phase shift from the samples before correlating the received signal with the known pilot sequence.

36. The method of claim 29 wherein correlating the received signal with the known pilot sequence further determines timing information associated with the information signal.

37. The method of claim 29 wherein processing the received signal comprises:
multiplying the known pilot sequence by the determined channel estimates to determine a received pilot sequence estimation;
subtracting the received pilot sequence estimation from the received signal to generate a first information signal estimate; and
decoding the first information signal estimate using the channel estimates to determine a second information signal estimate.

38. The method of claim 29 wherein processing the received signal comprises decoding the received signal using the determined channel estimates to remove the pilot sequence from the information signal while decoding the information signal.

39. The method of claim 29 wherein determining the channel estimates comprises filtering the one or more correlation values to determine the channel estimates.

40. The method of claim 29 further comprising applying one or more de-correlation vectors to the received signal before correlating the received signal with the known pilot signal.

41. The method of claim 29 wherein the received signal comprises a complex received signal, and wherein correlating the received signal with the known pilot sequence comprises:
de-rotating samples of the received signal by one or more predetermined angles to align all samples with the real axis; and
adding the de-rotated samples to determine the channel coefficients.

42. A wireless device comprising a receiver to receive a wireless signal, wherein the received signal comprises a linear combination of a known pilot sequence and an information signal transmitted over a propagation channel using the same multiplexed radio resource, the receiver comprising:
a correlator to correlate the received signal with the known pilot sequence to determine one or more correlation values;
a channel estimator to determine channel estimates for the propagation channel based on the one or more correlation values; and
a signal processor to process the received signal using the determined channel estimates to remove the pilot sequence from the information signal.

43. The wireless device of claim 42 wherein the receiver comprises a CDMA receiver, and wherein the received signal comprises a linear combination of the known pilot sequence and the information signal transmitted over the propagation channel using the same orthogonal spreading code.

44. The wireless device of claim 42 wherein the receiver comprises a TDMA receiver, and wherein the received signal comprises a linear combination of the known pilot sequence and the information signal overlapping the same symbol periods within an allocated time slot.

45. The wireless device of claim 42 wherein the receiver comprises an OFDM receiver, and wherein the received signal comprises a linear combination of the known pilot sequence and the information signal transmitted over the propagation channel using the same set of subcarrier frequencies during the same OFDM symbol block period.

46. The wireless device of claim 42 wherein the correlator is configured to correlate the received signal with multiple time shifts of the known pilot sequence.

47. The wireless device of claim 42 wherein the correlator is configured to correlate multiple time shifts of the received signal with the known pilot sequence.

48. The wireless device of claim 42 wherein the correlator is further configured to apply one or more progressive phase rotations to samples of the received signal to remove an hypothesized Doppler phase shift from the samples before correlating the received signal with the known pilot sequence.

49. The wireless device of claim 42 wherein the channel estimator is further configured to determine timing information associated with the information signal based on the correlations between the received signal and the known pilot sequence.

50. The wireless device of claim 42 wherein the signal processor comprises:
a multiplier to multiply the known pilot sequence by the determined channel estimates to determine a received pilot sequence estimation;
a combiner to subtract the received pilot sequence estimation from the received signal to generate a first information signal estimate; and
a decoder to decode the first information signal estimate using the channel estimates to determine a second information signal estimate.

51. The wireless device of claim 42 wherein the signal processor comprises a decoder to decode the received signal using the determined channel estimates to remove the pilot sequence from the information signal while decoding the information signal.

52. The wireless device of claim 42 further comprising a de-correlator connected to an input of the channel estimator and configured to apply one or more de-correlation vectors to the received signal.

53. The wireless device of claim 42 wherein the received signal comprises a complex received signal, and wherein the channel estimator comprises:
a rotation unit to de-rotate samples of the received signal by one or more predetermined angles to align all samples with the real axis; and
a combiner to add the de-rotated samples to determine the channel coefficients.
